(19) United States
(12) Patent Application Publication
(10) Pub. No.: US 2012/0038278 A1
(43) Pub. Date: Feb. 16, 2012

(54) ELECTRONIC INVERTER WITH PROTECTION FOR DISCHARGES PRODUCED BY MALFUNCTIONING IN GAS DISCHARGE OR FLUORESCENT LAMPS AT THE END OF THE SERVICE LIFE THEREOF

(76) Inventor: Guido Arena Ochoa, Naucalpan (MX)

(21) Appl. No.: 13/266,413

(22) PCT Filed: May 20, 2010
(86) PCT No.: PCT/MX10/00041

§ 371 Date: Oct. 26, 2011

(30) Foreign Application Priority Data
Nov. 10, 2009 (MX) MX/A/2009/012150

(51) Int. Cl. H05B 41/285

(52) U.S. Cl. 315/127

(57) ABSTRACT

A full-wave electronic inverter for supplying one or more low-pressure gas discharge or fluorescent lamps, which inverter is protected by a circuit containing a small tubular core saturable transformer which has the inductive reactance necessary and sufficient for deflecting, from the circuit thereof, the asymmetrical waves which are at a frequency higher than the frequencies stipulated by design and are produced by said lamps at the end of the service life thereof, preventing the inverter from burning out, as occurs with inverters of that type which do not have said circuit which also enables the situation in which, although the inverter is still being connected to the supply circuit, the inverter does not consume energy, even though said lamp or lamps is/are connected to the circuit thereof, until said lamps are replaced with new lamps. This inverter has a starting button which is used to deenergize the inverter each time the latter operates for the first time with new lamps.

### OBJECT OF THE INVENTION

The object of this invention to provide a full-wave inverter, characterized by being protected against the phenomena generated through the life of the lamp and to remain useful, when the lamp connected to the circuit reaches the end of his life and can be replaced in the same investor for a new lamp, the inverter stops operating at the time of failure of the lamp. To achieve this goal, consider all the performance characteristics of the lamps over their lives, thereby protecting its two transistors to be the exposed part, because these transistors for placement in any anomaly in the circuit overlapping signal driving cycle being short-circuited these.

Another advantage of this invention is that its signal circuits for alternately switching two transistors, be carried out using diodes instead of capacitors which removes all internal shocks as this mode signal currents not interrupted only change in a harmonious way, so efficiency is achieved by a range greater than three percent, compared to existing investors.

Despite the high efficiency, as is known has the gas discharge tube or fluorescent low pressure, as well as longer duration than is the order of ten times the life of the incandescent bulb. Having to replace the entire set when the lamp reaches the end of his life, this hurts his qualities as compared to the cost of incandescent bulb, which is about ten times smaller than the rectifier-inverter set over the lamp.

In order to more fairly compare the fluorescent lamp with incandescent bulb, taking into account their luminous efficiency, the fluorescent lamp is 68 lumens/Watt incandescent bulb and has only 10 to 15 lumens/Watt. (IES Lighting Handbook 8-9, 8-11, 8-26). The time-cost relationship of common incandescent light bulb, it is perfectly determined to penetrate every major economy in the lowest. Through this invention, the fluorescent lamp life can be calculated similar to the common incandescent light bulb and this will save energy with less initial cost.

When it first acquires the whole lamp investor attaches the rope turning the plug (socket) as is conventional today, and through this invention, the new lamp is easy to connect since the investor even if there is connected to the supply circuit, the lamp remains molten rock it and therefore without consuming energy, until you press the reset button normally open position, placed in the body of the investor, after installing the new lamp, which may have two terminals or contacts at each end, similar to those of the current Rapid start lamps. As the cost of the inverter of this invention is competitive with existing investors, can take advantage of lamp replacements and cost apportioning the cost of new lamps.

### BACKGROUND

The inverter circuit full wave considered here are designed to convert an input voltage direct current output voltage to a high frequency of about 20 kHz. to 100 kHz, used as ballast in gas discharge lamps or fluorescent low pressure, more particularly mentioned here only as a lamp. These lamps can be of various types, most suitable for this type of investor is classified as a quick start by being more efficient than cold-cathode. The power of these investors may be obtained from the mains AC through rectifier circuits based on diodes and capacitors used as filters or as a voltage doubler or pulse modulator circuits and other arrangements, this in order to prevent harmonics generated by the power supply capacitors, which are used as needed according to required standards.

These inverter circuits consisting of two transistors have the same characteristics, which are connected in series between the positive terminal (±) and negative (−) power inverter, which lead alternative is in series with the lamp at the time driving and this is achieved by means of a small toroidal core transformer, the signal induced in its windings conduct alternately driving the transistors. The lamp is in turn connected in series with an inductor and a capacitor, which is achieved current response to a sinusoidal voltage and resonant frequency of the predetermined system.

These lamps have tungsten filaments mixed with alkaline oxides are placed at each end, and to emit electrons produced through the gas discharge containing the lamp. The temperature of these filaments in normal operation is 1100 degrees Celsius (Page R IES Lighting Handbook 8-19.), And are heated by the investor permanently ending the life of the lamp when the filaments cease to issue or are interrupted. The electric arc inside is made by the gases that mainly contains argon gas and the electric current increases the arc instantly gasified mercury, which also contains in its interior.

These investors have the advantage of not using output transformer for the lamp, because they exploit the advantages of today's transistors, which can be switched at high voltages (several hundred volts).

At present, these investors for their high efficiency and good response to the lamp, they tend to supply the incandescent bulb. It is easy to see that she is about to end the life of a lamp, one ends emits more red light flashes on the other, as the tungsten filament does not sublimate her in the same way, leading one over the other and so your downloads are not symmetrical, as well as the gas becomes more conductive by the sublimation of tungsten, reducing the voltage across the lamp, asymmetrical and discharging more often than those of normal operation.

This phenomenon may last several hours, whereas conventional electromagnetic ballast for this phenomenon is not important, especially for this type of investor is highly detrimental for the asymmetry and duration of discharge and which directly affect the operating cycle of its transistors. These discharges pass through the primary winding of the transformer reflected in alternating cycles of the driving transistors having asymmetry in the waveform, this overlap is reflected in the driving cycle of the transistors putting short circuit, be those directly connected between the positive and negative terminals of the inverter power and operate alternately. So, when the lamp is also merges merges the investor. In the U.S. Pat. Indicates that there are U.S. Pat. No. 4,782,268 to replace the electronic circuit with the lamp when it fails. In the invention: MX Pat. Pat. 1111901 CA 143143, U.S. Pat. No. 4,276,496, is an early investor only half-wave, where the consequences of this phenomenon of a malfunction of the lamp, are damped in this case based on negative feedback and a non-saturable core transformer however, the investor continues to oscillate with the lamp melted and reaches its output transistor to fail by heating.

### BRIEF DESCRIPTION OF THE FIGURES

The diagrams shown here help to understand as illustrative features of the invention:

FIG. 1 is a complete diagram of the inverter voltage doubler rectifier and lamp in the circuit.

FIG. 2 is a diagram illustrating the course of currents in the energized phase inverter element.

FIG. 3 is a diagram illustrating the course of currents at the stage of de-energized elements of the inverter.

FIG. 4 is a diagram illustrating an electric arc lamp in the stage of a malfunction at the end of its useful life.

FIG. 5 shows the tubular core transformer in detail.

FIG. 6 shows an image of an electrical discharge in the lamp at the end of his life, obtained through digitizing oscilloscope and camera 2255 model tester AM503B DCS01 and current amplifier.

FIG. 7 shows the current in the lamp in normal operation, during its lifetime obtained with the same team.

FIG. 8 shows how you can connect more than one lamp to the circuit in FIG. 1 by adding the capacitor 44 in series with the lamp 49 and the positive side (+) 34, the capacitor 46 in series with the filament 45 and filament 47 and the inductor 48, in parallel with the inductance 7.

### DETAILED DESCRIPTION OF THE INVENTION

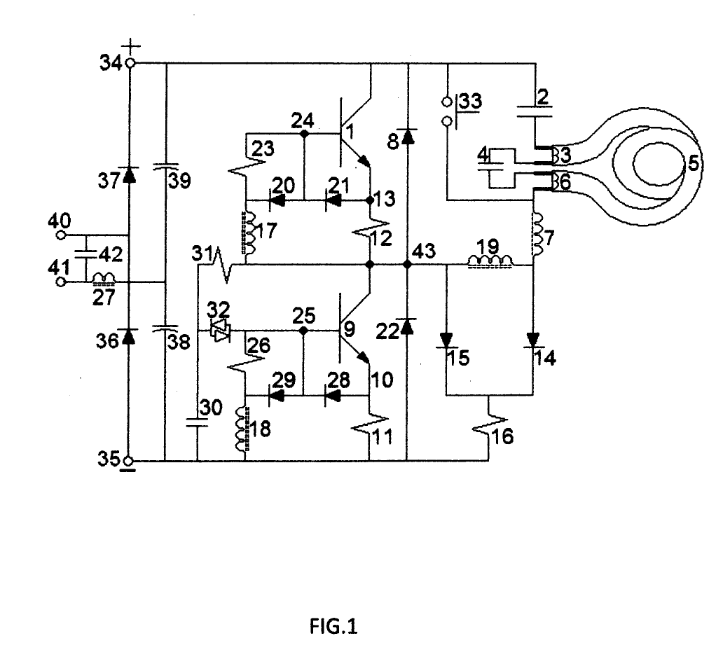

Referring to FIG. 1, diodes, 8 and 22, commonly called free-bearing, which are usually built by the manufacturer in the body of the transistor used to protect the peak-inverse voltage. In order to have greater response in these diodes in the invention connects the diode 8, the positive (+) 34, point 43, excluding the resistor 12 and diode 22, negative (−) 35, to the point 43, excluding the resistance 11.

The operation of the starting circuit of the inverter is as follows: Once the circuit connected at the source of AC power at points 40 and 41, capacitors 38 and 39, due to the rectifier diodes 36 and 37 as known, between the point negative (−) 35 and, the positive (+) 34, there is a full-wave rectified voltage twice the voltage of AC power.

Based on the positive side (+) 34, the condenser 2, the filament 3, the condenser 4, and 6 both filament lamp 5, the inductance 7, the primary winding 19, the resistance 31 and the capacitor 30 closes the circuit at the negative (−) 35, and when the capacitor 30, is energized, the diac 32 is placed on letting conducting state current at the point 25 which is the base of the transistor 9, the issuer that is the point 10, and through the resistance 11, negative (−) 35. As the transistor 9, begins to conduct.

In order to give greater clarity to the investor behavior of this particular operation is considered in two stages: energizing stage and the stage of de-energization.

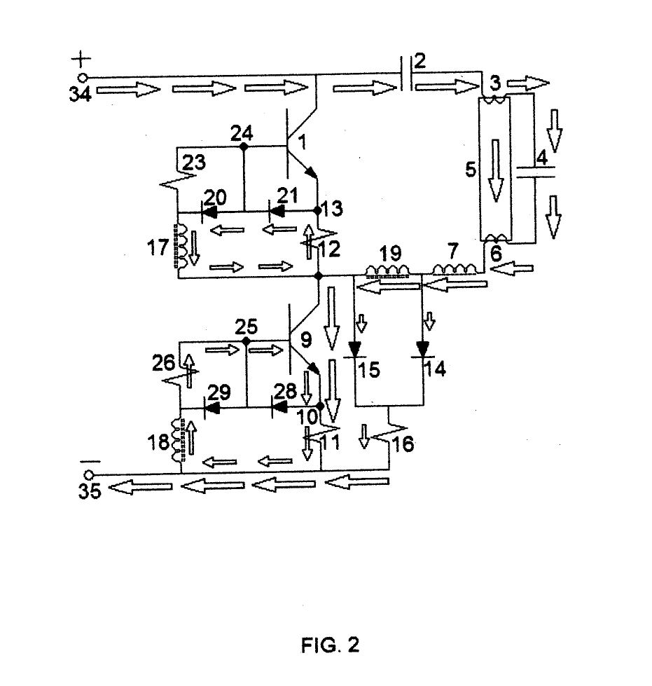

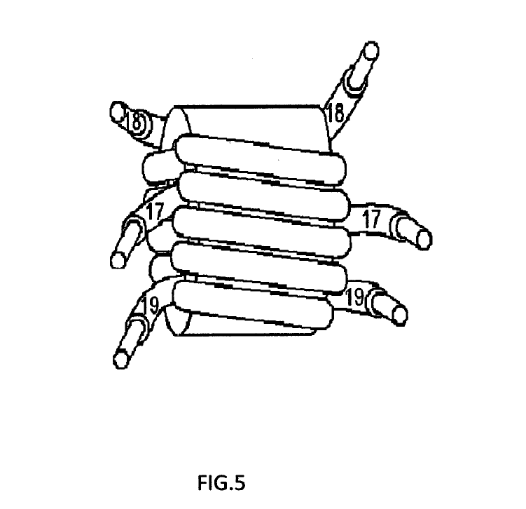

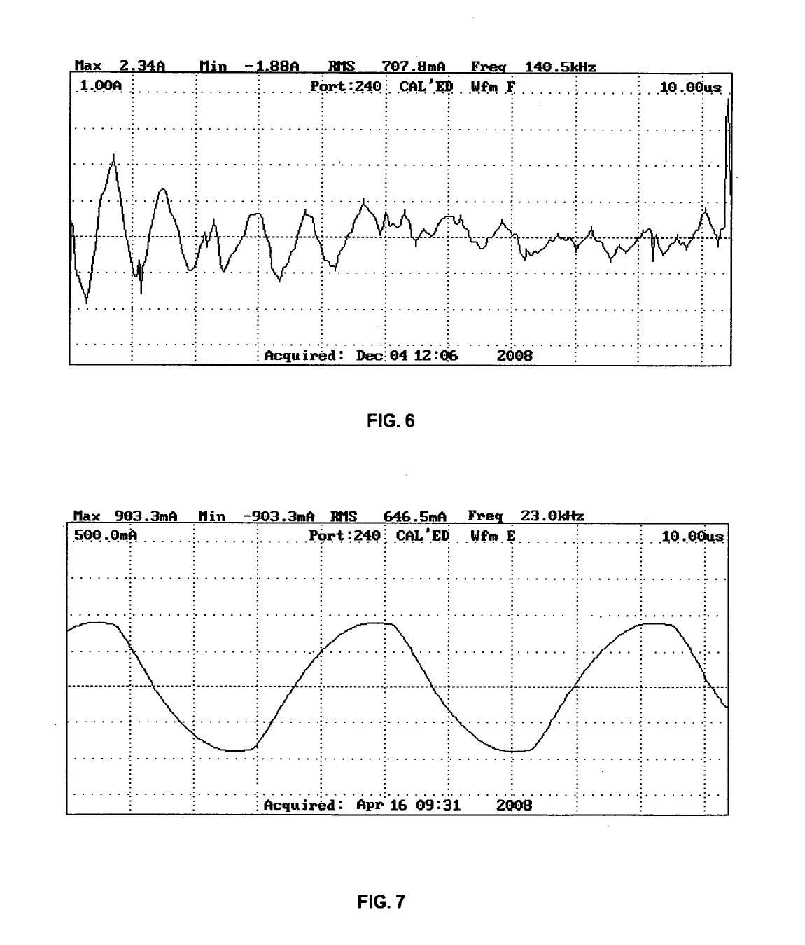

Once the driver to start driving transistor 9, In FIG. 2 one can observe in detail the energization of the inverter stage, which begins at the point positive (+) 34, where the current passes through the condenser 2 and through strand 3, the condenser 4, and the filament 6, both of the lamp 5, while between these filaments of the lamp 5, making the electric arc passes through the inductor 7, the primary winding 19 by the collector the transistor 9, and its emitter 10, 11 resistance, and negative (−) 35. Simultaneously, the primary winding 19 magnetically coupled to the tubular core transformer for simplicity not drawn into the channels and clearly shown in FIG. 5, which induces a voltage in the secondary winding 18, FIG. 2, which generates the current flowing through the resistor 26, and the point 25, which is the base of the transistor 9, paragraph 10, which is the issuer and the resistance 11, closing the circuit at the secondary winding 18, bringing the transistor 9, at maximum driving and therefore the maximum discharge lamp 5. The current generated in the secondary winding 18, circulates in positive direction, ie in the same direction as clockwise as illustrated in FIG. 2. Simultaneously by opposing secondary winding 17, generating a current through the resistor 12, for item 13, the diode 21 and the diode 20, closing the circuit at the secondary winding 17 antagonist. As you can see, the point 13, which is the emitter of the transistor 1 has greater potential than the point 24, which is the base of transistor 1, so that the transistor does not conduct, being energized, the capacitor 2 and the condenser 4. This stage concludes energizing the inverter when the tubular core of the transformer FIG. 5, is saturated.

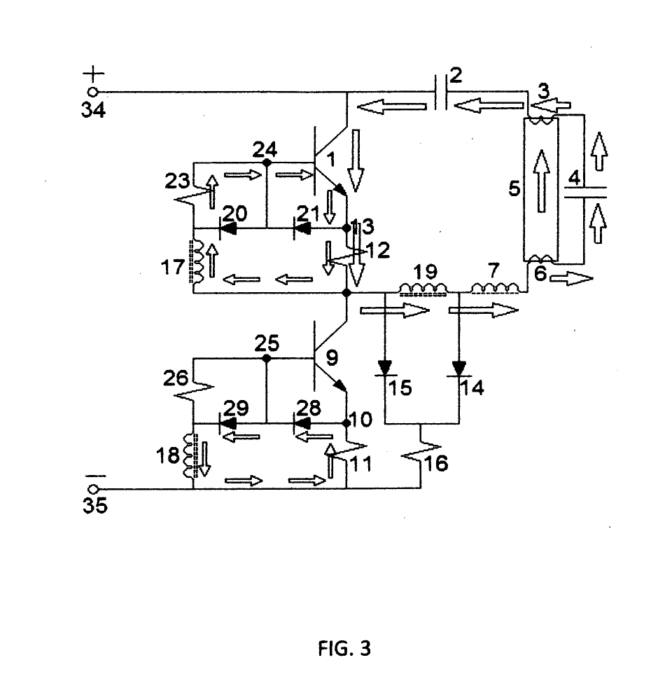

In that instant you start the cycle of de-energizing reversing a principle known in the inverter currents FIG. 3, antagonist in the secondary winding 17, generating a current flowing in the positive direction, which passes through the resistor 23, for Item 24 is the base of transistor 1, point 13 which is the emitter of the transistor 1, and the resistor 12, closing the circuit at the secondary winding 17 antagonist, this current acts on the transistor 1, putting it in your state of maximum driving. Simultaneously in the secondary winding 18, generates a current that flows from the negative through the resistor 11, at point 10, the diode 28, through diode 29, closing the circuit at the secondary winding 18. As you can see the point 10 is more positive than about 25, so that the transistor 9 can not drive and the stage of de-energization of the investor ends when the capacitor 2 and the capacitor 4 is discharged completely.

The stages of energizing and de-energization in the discharge of the lamp currents and voltages are sinusoidal, corresponding energizing phase inverter to the positive side of the sinusoid, and the stage of de-energizing the negative side. The system operating frequency is determined by the total value of capacitance and inductance that contain inverter circuits, and can be calculated using the formula known for resonant circuits.

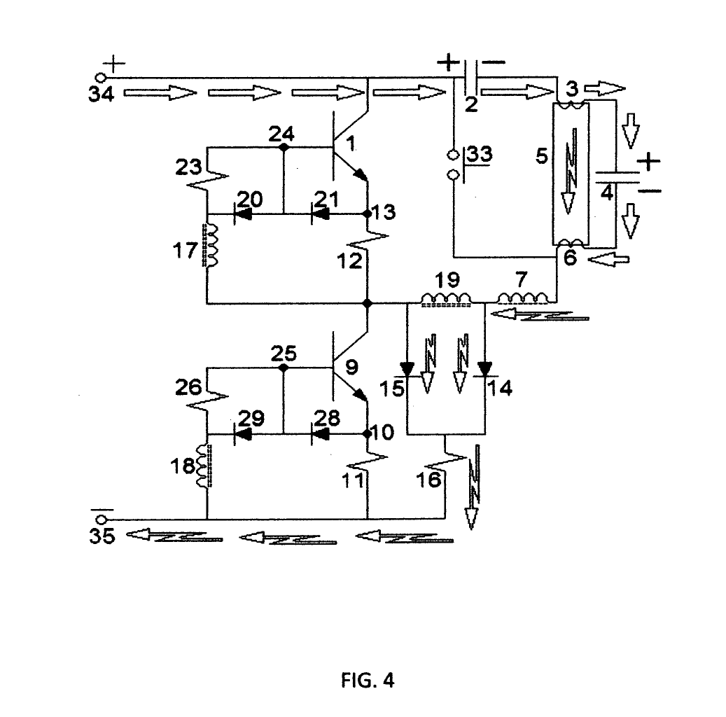

As shown in FIG. 2, and FIG. 3, in the circuits for driving and driving in non-Transistor 1 and 9, the currents induced change their meaning in harmony but not interrupted for the purpose of no discharges and transients generated within the circuit itself can affect the proper operation of the inverter, improving its operation up to three percent compared to current investors. FIG. 4 is a diagram illustrating the behavior of the currents generated by malfunction of the lamp 5, the end of life, non-symmetrical shock and at a frequency higher than normal operation. As you can see the current point of the positive (+) 34, passing through the condenser 2, the filament 3, the condenser 4, the filament 6, the discharge of a malfunction of the lamp 5, through the inductor 7, and the primary winding 19, which has the necessary and sufficient inductive reactance to limit these current waveforms.

These lengthy downloads generate heat in the primary winding 19, in order to avoid these warm, this invention has a circuit of two high recovery diodes 14 and 15, whose anodes are directly connected respectively to the ends of primary winding 19, and cathodes which are linked together connected to a resistor 16, where its other end is directly connected to the negative potential of the circuit point 35, and thus is able to send negative (−) 35, more frequent discharges to the stipulated so the primary winding 19 can not induce enough voltage in the secondary winding 17 antagonist, so that it can generate enough current to make the transistor driver 1 and the condenser 2 and the condenser 4, can not be downloaded what the investor ceases to oscillate. For very low power lamps under 10 watts, heating of the primary winding 19, is not very strong so that cost savings can eliminate high recovery rectifiers 14 and 15 and the resistor 16, as the circuit ceases to operate due to the inductive reactance of the primary winding to the position of the resistance 31, FIG. 1 not send start signal, the capacitor being charged 2 and 4, having an abnormality or malfunction of the lamp in with the patent.

Once connected a new lamp button is pressed manually contact 33, FIG. 1, normally open position so that the capacitor 2 and the capacitor 4 through the strands 3 and 6, the new lamp 5, download and return the investor to operate as normal.

For the capacitors 2 and 4, remain energized and the inverter stops scrolling in case of malfunction of the lamp 5, it is necessary that the resistance 31, is connected across the primary winding 19, the inductance 7, strands 3 and 6, the lamp 5 and the capacitor 4 and 2, the positive (+) 34 in the old technology the resistance 31 is directly connected to the feeder pole 34 or 35, so the diac 32, will be sending impulses causing the transistor 9, the driver no matter what the discharge lamp, as investors continue swinging to prevent the transistor 9, stop driving discharging the capacitor 2 and the capacitor 4 through the transistor 1.

The characteristic high inductive reactance of the tubular core transformer FIG. 5, the minimum is achieved by maintaining the path of the magnetic field lines at its core, this dimension is limited in its inner diameter to space windings requiring three turns with minimal and to reduce the reluctance of the core is necessary to increase the cross sectional area without increasing the magnetic flux path and this is achieved by increasing the longer side of its cross section, so that said core acquires its tubular shape and its length is increases to a limit such that the resulting inductive reactance does not decrease the resonant frequency of design, as well as to limit discharges of higher frequency to pass through its windings.

The capacitor 42 and inductor 27 form a filter to protect the inverter circuit on phenomena that occur in the line of AC power connected to points 40 and 41.

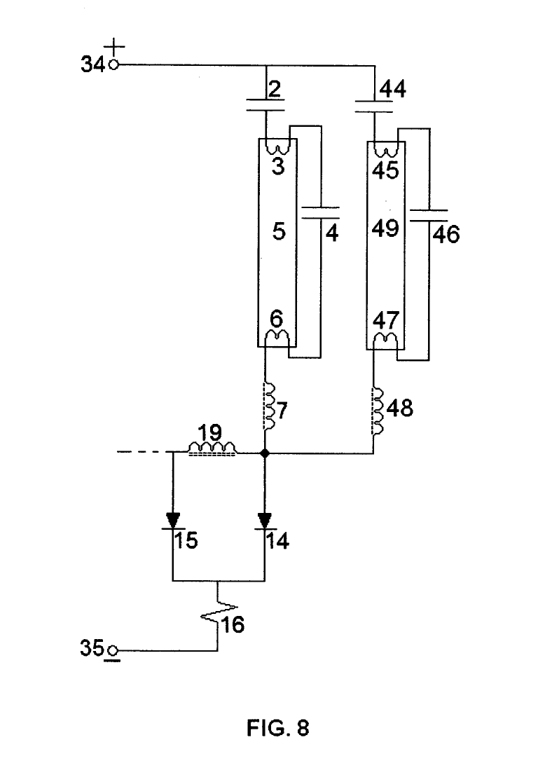

Values of a circuit illustrating the invention FIG. 1 and FIG. 8.

We present two cases 17 Watts and 80 Watts to illustrate the scope that has the invention.

Voltage doubler to 120 volts AC power in both cases.

| For a lamp of 17 Watts | For two lamps of 40 Watts |
|---|---|
| 1, 9, Transistor | 1, 9, Transistor |
| MJE 13007 To 220 | MJE 13007 To 220 |
| 2, capacitor polyester | 2, 44, polyester capacitor |
| .047 UF to 400 v | .047 uF to 400 v |
| 4, polyester capacitor | 4, 46, polyester capacitor |
| .0039 UF at 1600 V | .021 uF at L600 V |
| 38, 39 electrolytic capacitor | 38, 39 electrolytic capacitor |
| 22 uF a 250 v | I00 uF a 250 v |
| 7, Inductance 4.27 mH | 7, 48, inductance 2.86 mH |
| 11, 12 9 ohms Resistance | 11, 12 9 ohms Resistance |
| Diode AR | Diode AR |
| 14, 15, 8, 20, 21, 22, 28, 29, | 14, 15, 8, 20, 21, 22, 28, 29, |
| 36, 37 Diode 1N4007 | 36 37 1N4007 diode |
| 16, 6.6 megohms Resistance | 16, Resistance 70 kohms |
| 23, 26, 6.8 ohms Resistance | 23, 26, 6.8 ohms Resistance |
| 30, ceramic capacitor | 30 ceramic capacitor |
| .014 UF at 600 v | .0047 uF at 600 V |
| 31, 50 k ohms Resistance | 31, 100 k ohms Resistance |
| 32, DIAC DB3 | 32 DIAC DB3 |
| A core transformer of a | A core transformer of a |
| tubular shape | tubular shape |
| .122″ × .111″ × .244″ | 314″ × .227″ × .347″ |
| primary coil | primary coil |
| two windings | two windings |
| secondary coil | secondary coil |
| three windings | three windings |
| 27 Inductance Capacitor .01 mH | 27 Inductance Capacitor .01 mH |
| 42 Polyester Capacitor | 42 Polyester Capacitor |
| .047 uF 600 v | .047 uF 600 v |

1-7. (canceled)

8. An electronic investor protection with automatically generated by malfunctions in gas discharge lamps or fluorescent lamps at the end of its useful life, characterized by having:
resistance (31), that one end is connected in series with the primary winding (19), inductance (7), the filament (6) Lamp (5), the condenser (4), the filament (3) of the lamp (5), condenser (2), to the point positive (34), and at its other end is connected to the diac (32), and the capacitor (30), while it is connected to the negative (35), in order that the diac (32), do not enter the on state when the lamp is operating in bad condition to be charged capacitors (2) and (4), not allowing the passage of current through the resistor (31), leaving the investor to oscillate.

9. An electronic inverter according to claim 8 characterized by having a circuit for driving their non-Transistor (1), which is part of the secondary winding antagonist (17), which one end is connected to a resistor (12), and at its other end is connected to point (13), which is emitter of the transistor (1), and the anode of the diode (21) whose cathode is connected to the anode of the diode (20), and in turn the base (24) of the transistor (1), and the cathode of the diode (20), is connected to the other end of the secondary winding antagonist (17) closing the circuit.

10. An electronic inverter according to claim 8 characterized by having a circuit for driving their non-Transistor (9), which is part of the secondary winding (18), which one end is connected to a resistance (11), and at its other end is connected to the point (10) which is the emitter of the transistor (9), and the anode of the diode (28) whose cathode is connected to the anode of the diode (29), and in turn to the base (25) of the transistor (9), and the cathode of the diode (29) is connected to the other end of the secondary winding (18) thus closing the circuit.

11. An electronic inverter according to claim 8 characterized by having a manual contact button (33), normally open position in a end thereof is connected to the positive point (34), and the other end to the junction between the inductor (7), and the filament (6), lamp (5), for when the oscillator is locked by malfunctioning lamp (5), press the manual contact (33), normally open position and discharge the capacitor (2), and the condenser (4) and thus can pass a current through the resistance (31), thereby driving state of the diac (32), starting again the oscillation of the inverter to connect a new lamp.

12. An electronic inverter according to claim 8 characterized in that it contains at each end of the primary winding (19) respectively connected to the anodes of two diodes (14) and (15), whose cathodes are linked together directly connected to resistance (16), whose other end is directly connected to the negative (35), in order to send to the negative (35) flows to that prescribed most often generated by the lamp (5).

13. An electronic inverter according to claim 8, wherein the circuit contains one or more gas discharge lamps or fluorescent adding the capacitor (44) in series with the lamp (49), and the positive point (34), the condenser (46), in series with the filament (45), and the filament (47) and inductance (48), in parallel with the inductance (7), for each lamp.
